(19) United States
(12) Patent Application Publication
(10) Pub. No.: US 2003/0188196 A1
(43) Pub. Date: Oct. 2, 2003

(54) E-mail security audit system for company security

(76) Inventor: Jeong-Hwan Choi, Seongnam (KR)

Correspondence Address: Peter T Kwon, Kang Nam P O Box 2301, Seoul, 135-651, KR

(21) Appl. No.: 10/297,045

(22) PCT Filed: May 29, 2001
(86) PCT No.: PCT/KR01/00899

(51) Int. Cl. H04L 9/00

(52) U.S. Cl. 713/201

(57) ABSTRACT

An email security system for company security is disclosed. The email security system has a transmission server and a reception server. The transmission server has a mail code assigning and mail separating unit, a database, a security violation checking unit, a virus checking and curing unit, and a mail sending unit; and the reception server has a CGI operating unit. The security violation checking unit checks whether or not the email written and sent by a mail sender violates security, and sets a flag to prevent a mail receiver from reading the email if the email violates the security. The virus checking and curing unit checks whether the main body and the attached file are infected with computer viruses, and sets the flag to prevent the mail receiver from reading the email if the main body and the attached file are infected with the computer viruses.

### TECHNICAL FIELD

The present invention relates in general to an email security system, and more particularly to an email security system for preventing divulgement of company secrets and spread of computer viruses through emails by persons engaged in a company.

### BACKGROUND ART

As well known to those skilled in the art, an email is a system for exchanging information such as characters and voices with a mail format between terminals such as personal computers and workstations through a computer network, for example, the internet. As the internet has developed, email has become generalized and widely used. However, it is impossible to cancel the transmission of an email having been sent, due to properties of the email. In other words, providing that a person engaged in a company undesirably divulges internal secrets of the company to other persons not engaged in the company through an email, the secrets are already revealed even if the company perceives the divulgement of secrets. Consequently, the company must take an action only after divulgement of the secrets.

As described above, if an employee of a company intentionally divulges secret documents to a competitor company, the secret documents are revealed to the competitor company, causing harm to the source company.

### DISCLOSURE OF INVENTION

Therefore, the present invention has been made in view of the above problems, and it is an object of the present invention to provide an email security system for company security, which prevents the divulgement of company secrets to persons not engaged in the company by email users engaged in the company, and also prevents computer viruses from spreading through the computers(or terminals) of the email users, in addition to allowing the computer infected with viruses to be cured automatically even if the email sender's computer is infected with computer viruses.

In accordance with the present invention, the above and other objects can be accomplished by the provision of an email security system for company security comprising a transmission server, comprised of a mail code assigning and mail separating unit for assigning the transmission mail code to an email written by [symbol] r, and separating the email into a main body and a subject, a database for storing the transmission mail code, the main body and a file attached to the email, a security violation checking unit for checking whether or not the email written and sent by the mail sender violates security, setting a flag to prevent a mail receiver from reading the email if the email violates the security, and informing a security computer of the security violation, a virus checking and curing unit for checking whether or not the main body and the attached file are infected with computer viruses, and setting the flag to prevent the mail receiver from reading the email if the main body and the attached file are infected with computer viruses, and a mail sending unit for sending a subject of the email, the mail sender's mail identification (ID), the mail receiver's mail ID, and a transmission mail code, accompanied with a Common Gate Interface (CGI) or LINK for enabling the mail receiver to confirm the main body and the attached file; and a reception server comprised of a CGI operating unit for selecting and reading an email from the transmission server, requesting the main body and the attached file, and operating a mail main body and attached file providing unit in the transmission server such that the mail receiver reads the main body and receives the attached file.

Preferably, in order to prevent company secrets from being divulged by a person engaged in the company, the main body of the email and any file attached to the email, which are separated from the email by the mail code assigning and mail separating unit, are stored in the database, and also applied to the security violation checking unit for primarily checking a security violation of the email. In the preferred embodiment of this invention, the security violation checking unit and the virus checking unit are included in one server as shown and described later. However, those skilled in the art will appreciate that the security violation checking unit and the virus checking unit can be embodied as separate servers. In the primary check, if it is suspected that the email from the mail sender violates company security, the security violation checking unit sets a read prohibiting flag in the database, thus preventing the mail receiver from [symbol] email, and also informs a security computer—computer charged with company security—that the email violates company security. After being informed, the security computer finally checks whether or not the email violates company security. If the security computer determines that the email does not violate company security, the security computer releases the read prohibiting flag set in the database, such that the mail receiver reads the email. On the other hand, if conclusively determining that the email violates company security, the security computer deals with the mail sender violating security according to email managing guidelines and company rules.

Preferably, in order to prevent the mail receiver's computer from being damaged by an attached file infected with computer viruses when the mail sender sends a virus infected file attached to the email by mistake, the main body and the attached file separated by the mail code assigning and separating unit are applied to the virus checking and curing unit as well as the database and the security violation checking unit. The virus checking and curing unit checks whether the main body and the attached file are infected with computer viruses. If it is checked that the main body and the attached file are infected with viruses, the virus checking and curing unit sets the read prohibiting flag in the database, thus preventing the mail receiver from reading the email, and informs the mail sender that the email is infected with viruses. Simultaneously, the virus checking and curing unit cures the sender's computer infected with viruses automatically before the sender's computer is more significantly damaged by viruses.

Further, in order to delete a wrongly sent email or revise a wrongly written email, the transmission server includes a mail deleting/revising unit. The mail deleting/revising unit searches the mail codes stored in the database according to a mail deleting/revising request from the mail sender, and deletes/revises a main body of an email corresponding to the searched mail code.

### BRIEF DESCRIPTION OF DRAWINGS

The above and other objects, features and other advantages of the present invention will be more clearly understood from the following detailed description taken in conjunction with the accompanying drawings, in which:

FIG. 1 is a block diagram showing the construction of an email security system having functions of email security auditing, virus checking and secret divulgement preventing according to the preferred embodiment of the present invention.

### BEST MODES FOR CARRYING OUT THE INVENTION

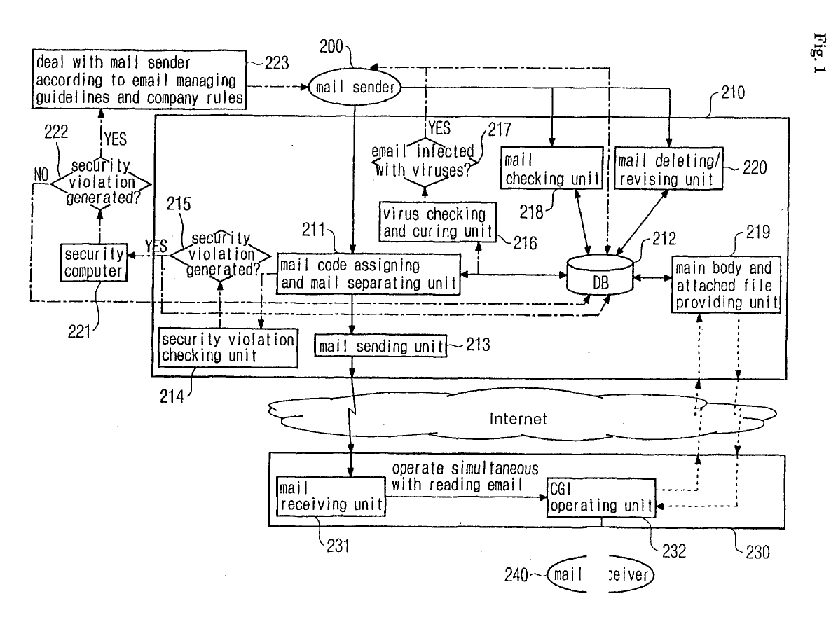

FIG. 1 is a block diagram showing the construction of an email security system having functions of preventing a divulgement of company secrets and a spread of computer viruses through an email according to the preferred embodiment of the present invention. Referring to FIG. 1, the email security system comprises a transmission server 210 and a reception server 230.

The transmission server 210 sends an email written by a mail sender 200 to a mail receiver 240. The transmission server 210 has functions of checking whether the email from the mail sender violates security, and whether a file attached to the email is infected with any viruses. The server 210 further has a function of preventing the mail receiver from reading the email that violates security if the email violating security is detected. Further, the transmission server 210 has functions of checking whether the email to be sent is infected with viruses, informing the mail sender of a checked result if the email is infected with viruses, and simultaneously preventing the mail receiver from reading the virus-infected email and automatically curing the mail sender's computer infected with viruses. For these functions, the transmission server 210 includes a mail code assigning and mail separating unit 211, a database 212, a mail sending unit 213, a security violation checking unit 214, a virus checking and curing unit 216, and a main body and attached file providing unit 219.

The mail code assigning and mail separating unit 211 assigns a transmission mail code to an email to be sent and separates the email into a main body and a subject(title).

The database 212 stores the transmission mail code, the main body and the attached files.

The mail sending unit 213 sends the email subject, the sender's mail identification (ID), the receiver's mail ID, and the transmission mail code, accompanied with a Common Gateway Interface (CGI) or LINK used for enabling the mail receiver 240 to confirm the main body of the email and the attached file.

Here, the main body separated by the mail code assigning and the mail separating unit 211 and the attached file are stored in the database 212, and also applied to the security violation checking unit 214. The security violation checking unit 214 checks whether the main body and attached file violate company security. If the main body and the attached file including internal secrets of a company are sent from the mail sender 200, the security violation checking unit 214 checks the security violation, and sets a read prohibiting flag in the database 212, thus preventing the mail receiver 240 from reading the email including the internal secrets. In this case, the security violation checking unit 214 informs a security computer 221 that the email from the mail sender 200 violates security. The security computer 221 determines whether or not the email violates any security 222. If it is determined that the email does not violate any security, the security computer 221 resets the read prohibiting flag by the security violation checking unit 214, thereby allowing the mail receiver 240 to read the email from the mail sender 200. On the other hand, if determining that the email violates security, the security computer 221 deals with the mail sender 200 who violates security according to email managing guidelines and company rules.

The main body separated by the mail code assigning and separating unit 211 and the attached file are stored in the database 212, and also applied to the virus checking and curing unit 216 as well as the security violation checking unit 214. Checking and curing unit 216 checks whether the main body and the attached file are infected with computer viruses. If it is checked that the main body and the attached file are infected with viruses, the virus checking and curing unit 216 sets the read prohibiting flag in the database 212 to prevent the mail receiver 240 from reading the email, and informs the mail sender 200 that the email is infected with viruses. Simultaneously, the virus checking and curing unit 216 cures the sender's computer infected with viruses automatically before the mail sender's computer is more significantly damaged by viruses.

The main body and attached file providing unit 219 provides the main body of the email and the file attached thereto, which are stored in the database 212, to the reception server 230 through the internet in response to a request for providing the main body and the attached file from a CGI operating unit 232 in the reception server 230.

The reception server 230 includes a mail receiving unit 231 and the CGI operating unit 232. The mail receiving unit 231 receives the email from the transmission server 210, and the CGI operating unit 232 selects and reads the received email, and sends the providing requests for the main body and the attached file to the main body and attached file providing unit 219. Also, the CGI operating unit 232 operates the main body and attached file providing unit 219 such that the main receiver 240 reads the main body of the requested email and receives the attached file.

Hereinafter, the operation of the email security system having the above construction of this invention is described in detail.

First, the mail sender 200 writes an email and sends the written email through the transmission server 210.

The mail code assigning and mail separating unit 211 assigns the transmission mail code to the email, and separates the email into the mail subject and the main body, and further stores the transmission mail code, the main body and the attached file in the database 212.

The mail sending unit 213 sends the subject, the mail sender's mail identification (ID), the receiver's mail ID, and the transmission mail code, accompanied with the CGI or the LINK used for enabling the mail receiver 240 to confirm the main body of the email and the attached file.

Here, the main body separated by the mail code assigning and the mail separating unit 211 and the attached file are stored in the database 212, and also applied to the security violation checking unit 214. As described above, the security violation checking unit 214 checks primarily whether the main body and attached file from the mail sender 200 violate company security 215. If the main body and the attached file including internal secrets of a company are sent from the mail sender 200, the security violation checking unit 214 detects the security violation of the email from the mail sender 200, and sets the read prohibiting flag in the database 212, thus preventing the mail receiver 240 from reading the mail including the internal secrets. In this case, the security violation checking unit 214 informs the security computer 221 of the security violation of the email. The security computer 221 determines conclusively whether or not the email violates any security 222. If it is determined that the email does not violate any security, the security computer 221 resets the read prohibiting flag by the security violation checking unit 214, thereby allowing the mail receiver 240 from reading the email. On the other hand, if determining that the sent email violates company security, the security computer 221 deals with the mail sender 200 who violates security according to email managing guidelines and company rules.

Further, the main body and the attached file are applied to the virus checking and curing unit 216 as well as the database 212, and the security violation checking unit 214. The virus checking and curing unit 216 checks whether or not the main body and the attached file are infected with computer viruses 217. If it is checked that the main body and the attached file are undesirably infected with viruses, the virus checking and curing unit 216 sets the mail reading prohibiting flag in the database 212 [symbol] ie mail receiver 240 from reading the email, and informs the mail sender 200 that the email is infected with viruses. Simultaneously, the virus checking and curing unit 216 cures the sender's computer infected with viruses automatically, before the sender's computer is significantly damaged by viruses.

Here, the email from the mail sender 200 is sent to the reception server 230, such that the mail receiver 240 reads the email. The process of opening and reading the email by the mail receiver 240 is described as follows.

The mail receiving unit 231 receives the email from the mail sending unit 213, and the CGI operating unit 232 executes the CGI or the LINK when the mail receiver 240 attempts to read the email, and so sends the transmission mail code to the mail main body and attached file providing unit 219. At this time, the mail main body and attached file providing unit 219 compares the transmission mail code from the CGI operating unit 232 with a transmission mail code stored in the database 212. If the transmission mail code from the CGI operating unit 232 corresponds to the stored transmission mail code, the mail receiver 240 reads the main body of the email through the main body and attached file providing unit 219 and the CGI operating unit 232, and also receives the file attached thereto.

In this case, the main body and the attached file stored in the database 212 are provided not from the mail sending unit 213, but from the mail main body and attached file providing unit 219 when the CGI operating unit 232 requests the provision of the main body and the attached file of the unit 219.

Then, the mail receiver 240 opens and reads the main body of the email, or receives the attached file, through the CGI or the LINK accompanied with the email.

Further, when the mail sender 200 desires to delete or revise the email, a mail deleting/revising unit 220 deletes or revises the email according to a mail deleting/revising request from the mail sender 200. Such deletion or revision can be performed due to a fact that the main body and the attached file are st [symbol] atabase 212.

As apparent from the above description, the present invention provides a mail security audit system, which enables a transmitting cancellation of an email violating security, an email infected with viruses, and automatic cure of the virus-infected computer (or terminal), thus allowing a company to quickly detect in advance a divulgement of internal company secrets over the internet. Also, the present invention is advantageous in that it cancels a transmission of the undesirably sent email, such that a company previously detects an secret divulgement and deals with a security infraction before significant damage is done, different from a conventional mail security system which takes an action against the security infraction after the internal secrets have been divulged. Further, the email security system of this invention is advantageous in that it prevents computer viruses from spreading outside the company through the internet by the mail sender, thereby preventing a deterioration of the company's service and functions by computer viruses. Consequently, the email security system of this invention has an effect that it completely solves the defects of the conventional email security system.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An email security system for company security, comprising:
(a) a transmission server, comprised of,
a mail code assigning and mail separating unit for assigning the transmission mail code to an email written by a mail sender, and separating the email into a main body and a subject,
a database for storing the transmission mail code, the main body and a file attached to the email,
a security violation checking unit for checking whether or n [symbol] ritten and sent by the mail sender violates security, setting a flag to prevent a mail receiver from reading the email if the email violates the security, and informing a security computer of the security violation,
a virus checking and curing unit for checking whether or not the main body and the attached file are infected with computer viruses, and setting the flag to prevent the mail receiver from reading the email if the main body and the attached file are infected with computer viruses, and
a mail sending unit for sending a subject of the email, the mail sender's mail identification (ID), the mail receiver's mail ID, and a transmission mail code, accompanied with a Common Gateway Interface (CGI) or LINK for enabling the mail receiver to confirm the main body and the attached file; and
(b) a reception server comprised of a CGI operating unit for selecting and reading an email from the transmission server, requesting the main body and the attached file, and operating a mail main body and attached file providing unit in the transmission server such that the mail receiver reads the main body and receives the attached file.

2. The system as set forth in claim 1, wherein the transmission server further comprises a mail deleting/revising unit for deleting/revising the email written by the mail sender.

3. The system as set forth in claim 1, wherein the transmission server has an email security function of setting a read prohibiting flag in the database by the security violation checking unit, thus preventing the mail receiver from reading a security-violating email and receiving the attached file if the mail sender sends an email containing the internal secrets of a company and then divulges the internal secrets of the company.

4. The system as set forth in claim 1, wherein the transmission server has a virus checking and curing function of setting a read prohibiting flag to prevent the mail receiver from reading a main body and receiving an attached file, informing the mail sender that the email is infected with viruses, and automatically curing the sender's computer infected with viruses if the mail sender transmits an email with a main body and an attached file infected with viruses.
